(19) United States
(12) Patent Application Publication
(10) Pub. No.: US 2006/0070767 A1
(43) Pub. Date: Apr. 6, 2006

(54) Adaptable electrical enclosures and methods for forming the same

(76) Inventors: Mark B. Clifton, West Windsor, NJ (US); Ivan Pawlenko, Holland, PA (US); Larry Samson, Langhorne, PA (US)

Correspondence Address: HARNESS, DICKEY & PIERCE, P.L.C., P.O. Box 8910, Reston, VA, 20195, US

(21) Appl. No.: 10/953,457

(22) Filed: Sep. 30, 2004

(51) Int. Cl. H01B 7/00

(52) U.S. Cl. 174/135

(57) ABSTRACT

Electrical enclosures are formed from a plurality of subcomponents, each of a predetermined size. By varying the positions of some of the subcomponents, the size of the enclosure may also be varied. The use of such subcomponents to form enclosures is less labor-intensive than previous techniques.

### BACKGROUND OF THE INVENTION

Existing enclosures for electronic assemblies consist largely of pieces of sheet metal that have been cut, formed and assembled together. Because there are many types of electronic assemblies available today, there also exists many different enclosures of varying sizes. Typically, to make an enclosure of a particular size, sheet metal is cut to form pieces of various, required lengths. These pieces are then formed and assembled.

This process is very labor-intensive because each different size enclosure typically requires a cutting machine to be separately prepared, adjusted or otherwise set up in order to cut pieces to specified lengths.

Accordingly, it is desirable to provide for enclosures which can be formed using techniques that involve less, labor-intensive preparation and setup.

### SUMMARY OF THE INVENTION

We have recognized that the labor involved in forming electrical enclosures can be reduced by forming enclosures using a plurality of subcomponents, where each subcomponent has a predetermined size. The use of subcomponents with predetermined sizes greatly reduces the time required to form an enclosure. Instead of separately preparing, and setting up a cutting machine in order to form sheet metal pieces of varying sizes, subcomponents of predetermined sizes are pre-cut and available to use to form an electrical enclosure.

The present invention also provides for means for forming an electrical enclosure of varying size from the subcomponents without changing the size of any of the subcomponents. More specifically, overlapping means (e.g., one or more channels) are used to create enclosures of varying sizes. Once a certain size has been formed using the overlapping means, connection means (e.g., a slotted key arrangement) are provided for connecting one or more overlapped subcomponents to form a sized enclosure.

### BRIEF DESCRIPTION OF THE DRAWINGS

FIG. 1 depicts an electrical enclosure according to one embodiment of the present invention.

FIG. 2 depicts an example of an overlapping means according to one embodiment of the present invention.

### DETAILED DESCRIPTION OF THE INVENTION

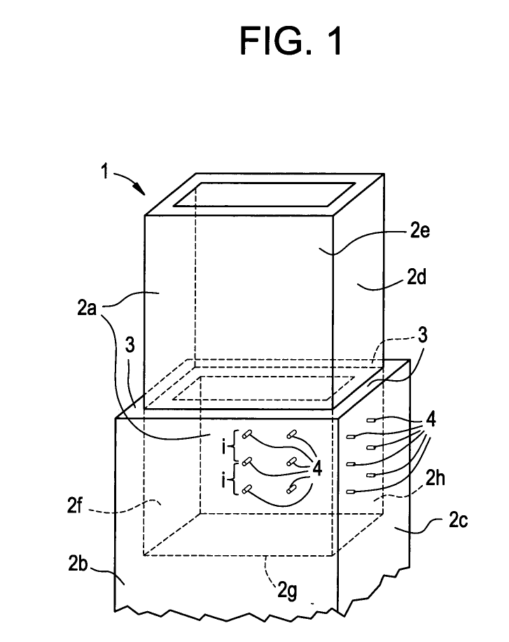

Referring now to FIG. 1, there is shown a plurality of subcomponents 2a-2h which may be used to form an electrical enclosure 1 according to one embodiment of the present invention. Each of the subcomponents 2a-2h has a predetermined size. That is, each of the subcomponents 2a-2h have already been cut to a particular size in accordance with a specific design. Because each of the subcomponents 2a-2h have been cut to a predetermined size, there is little need to prepare and set up a cutting machine when the time comes to assemble an electrical enclosure using the subcomponents 2a-2h.

Though the subcomponents 2a-2h each have a predetermined size, their size need not be the same. That is, subcomponent 2a may be larger or smaller in dimensions than subcomponent 2b. If required, however, subcomponents 2a and 2b may be of an identical size. As used herein, the term “size” includes both size and shape of a subcomponent.

To form an electrical enclosure using the one or more subcomponents 2a-2h, the subcomponents must be connected together. In a further embodiment of the present invention, the enclosure 2 comprises means for forming an electrical enclosure of varying size from subcomponents 2a-2h without changing the size of any of the subcomponents. More specifically, this means may comprise an overlapping means 3, such as channels to form an electrical enclosure and connection means 4. The overlapping means 3 allows the positions of subcomponents to be varied (e.g., moved up and down) such that the overall length, width or height of the enclosure 2 may also be varied depending on the amount of overlap. Once the subcomponents have been placed in a desired overlapping position corresponding to a desired size of enclosure 2, the present invention provides for connection means 4 for connecting the one or more overlapped subcomponents to form a size enclosure.

In further embodiments of the present invention, the connection means may be selected from the group consisting of at least welds, rivets, and slotted keys, though it should be understood that other equivalent connection means may be used. In the case of a slotted key arrangement, the keys may be removed from the slots to allow the subcomponents to be re-positioned, forming a different size enclosure.

In yet a further embodiment of the present invention, the position of the connection means 4 may be varied such that it is located at selected positions separated by an interval (regular or irregular) so that by selecting a specific position of the connection means, a specific-sized enclosure can be formed.

Though the subcomponents may be made of many different materials, typically one or more of the subcomponents will be made from sheet metal.

To help hold the overlapped subcomponents prior to connecting them, the present invention also envisions the use of a novel fixture (not shown in FIG. 1). This fixture will act to hold subcomponents so that they may be connected together and to allow any additional trimming or finishing (e.g., painting, grinding, etc.) of the enclosure 2.

It should be understood that this fixture may comprise a unique fixture for each size enclosure or may comprise an adaptable fixture capable of being used with one or more different size enclosures.

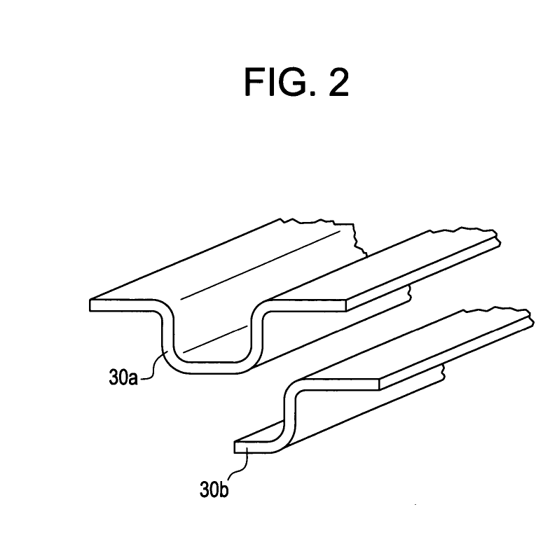

Referring now to FIG. 2, there is shown an example of overlapping means according to an embodiment of the present invention. Typically, the overlapping means comprises channels having V-shaped corners. However, the U-shaped overlapping means or channels 30a and 30b in FIG. 2 may also be used.

The discussion above has attempted to set forth some examples of adaptable electrical enclosures which are formed from subcomponents of predetermined sizes. These enclosures require less labor to create than conventional enclosures.

Modifications may be envisioned by those skilled in the art which may fall within the scope of the present invention as defined by the claims which follow.

We claim:

1. An adaptable, electrical enclosure comprising:
a plurality of subcomponents, each subcomponent having a predetermined size; and
means for forming an electrical enclosure of varying size from said subcomponents without changing a size of any of the subcomponents.

2. The enclosure as in claim 1 wherein the means for forming an enclosure comprises:
overlapping means for overlapping one or more of the subcomponents to create an enclosure of a certain size; and
connection means for connecting one or more of the overlapped subcomponents to form a sized enclosure.

3. The enclosure as in claim 1 wherein one or more of the subcomponents is made of sheet metal.

4. The enclosure as in claim 2 wherein the connection means is selected from the group consisting of at least welds, rivets and slotted keys.

5. The enclosure as in claim 2 wherein the overlapping means comprises one or more channels to receive one or more of the subcomponents.

6. The enclosure as in claim 2 wherein the connection means is located at a variable position, wherein the position determines a size of the enclosure.

7. A method for forming an adaptable, electrical enclosure comprising:
forming an electrical enclosure of varying size from a plurality of subcomponents, each subcomponent having a predetermined size, without changing a size of any of the subcomponents.

8. The method as in claim 7 further comprising:
overlapping one or more of the subcomponents to create an enclosure of a certain size; and
connecting one or more of the overlapped subcomponents to form a sized enclosure.

9. The method as in claim 7 wherein one or more of the subcomponents is made of sheet metal.

10. The method as in claim 8 further comprising connecting the subcomponents using means selected from the group consisting of at least welds, rivets and slotted keys.

11. The method as in claim 6 wherein the step of overlapping comprises overlapping one or more channels of the one or more subcomponents.

12. The method as in claim 6, further comprising fixing one or more of the overlapped subcomponents in a fixture in order to form one or more connections between the subcomponents.

13. The method as in claim 8 further comprising varying a connection position of one or more of the overlapped components to select a size of the enclosure.
